(19) United States
(12) Patent Application Publication
(10) Pub. No.: US 2013/0055148 A1
(43) Pub. Date: Feb. 28, 2013

(54) System and Method for Providing Controlled User Access to a Portable Electronic Device

(71) Applicant: Scott W. Lange, Atlanta, GA (US)

(72) Inventor: Scott W. Lange, Atlanta, GA (US)

(73) Assignee: KISMET Strategic Sourcing Partners, LLP, Saint Joseph, MI (US)

(21) Appl. No.: 13/592,554

(22) Filed: Aug. 23, 2012

Related U.S. Application Data
(60) Provisional application No. 61/526,295, filed on Aug. 23, 2011.

(51) Int. Cl. G06F 3/048

(52) U.S. Cl. 715/781

(57) ABSTRACT

A method of supplying a portable electronic device benefits one or more advertisers or their agent(s) or others while allowing the device to be provided free of charge to a target consumer. In exchange for the free electronic device, the user agrees to accept advertising placement on the machine. The device is provided with a resident controller which splits the screen into user-controlled and advertiser-controlled portions. The advertising material is played in the advertiser-controlled section of the screen, and the user is free to view other content and program activities in the user-controlled portion of the screen.

### FIELD OF THE INVENTION

The invention pertains generally to consumer electronic display and more particularly to a system and method of providing an advertiser controlled screen portion of a consumer electronic device display.

### BACKGROUND OF THE INVENTION

As consumer electronic devices become more powerful and interconnected, they provide an ever more valuable platform for advertisement placement. In addition, such devices provide numerous benefits to their respective users in terms of accomplishing tasks, enjoying entertainment, engaging in communications with other individuals or electronic devices and so on.

With respect to the placement of advertising materials on such devices, such materials are often displayed in a manner that they may be ignored or circumvented by the user to the detriment of the advertiser placing the material. For example, a user may send a page containing advertisement material to the background, or may otherwise continue to use the device without observing the advertisement,

With respect to the use of, and availability of, such devices to typical consumers, the initial cost of such devices is often prohibitive. In the inventor's view, if the advertiser were able to defray some or all of the initial cost such devices and at the same time be assured that the consumer did not simply close the advertisers displays, this would provide a mutual benefit to both the consumer and the advertiser. Unfortunately, there has to date been no system capable of meeting these various needs.

Thus, it is an object in part to provide a system and method for meeting the aforementioned need. However, while this is an object underlying certain implementations of the invention, it will be appreciated that the invention is not limited to systems that solve the problems noted herein. Moreover, the foregoing is a discussion of problems discovered and/or appreciated by the inventors, and is not an attempt to review or catalog the prior art.

### BRIEF SUMMARY OF THE INVENTION

A method of supplying a portable electronic device benefits one or more advertisers or their agent(s) while allowing the device to be provided free of charge to a target consumer. In exchange for the free electronic device, the user agrees to accept advertising placement on the machine. The device is provided with a resident controller which splits the screen into user-controlled and advertiser-controlled portions. The advertising material is played in the advertiser-controlled section of the screen, and the user is free to view other content and program activities in the user-controlled portion of the screen.

The agent supplying the device to the user may contract with multiple advertisers, and the advertising material loaded (and refreshed) on the device may advertise each contracted advertiser's product in turn. The agent may contract with each advertiser on a subscription basis for a monthly or other periodic fee to generate advertising revenue for the agent, which may offset the initial cost of each device to the agent in addition to providing an income stream.

### BRIEF DESCRIPTION OF THE SEVERAL VIEWS OF THE DRAWING(S)

FIG. 1 is a schematic diagram of a portable electronic environment within which embodiments of the present invention may be implemented;

FIG. 2 is a schematic diagram of a portable electronic device screen having a user-controlled screen portion vertically set off from an advertiser controlled screen portion;

FIG. 3 is a schematic diagram of a portable electronic device screen having a user-controlled screen portion horizontally set off from an advertiser controlled screen portion;

FIG. 4 is a flow chart showing a process for acquiring advertising material in an embodiment of the invention; and

FIG. 5 is a flow chart showing a process for displaying advertising materials to a user of a portable device such as that shown in FIG. 1 within an embodiment of the invention.

### DETAILED DESCRIPTION OF THE INVENTION

In general terms, not intended to limit the claims, the invention is directed towards a system and method for providing a portable electronic device to a consumer for use by the consumer, while ensuring that any advertising materials presented by the advertiser on the device remain observable to the consumer.

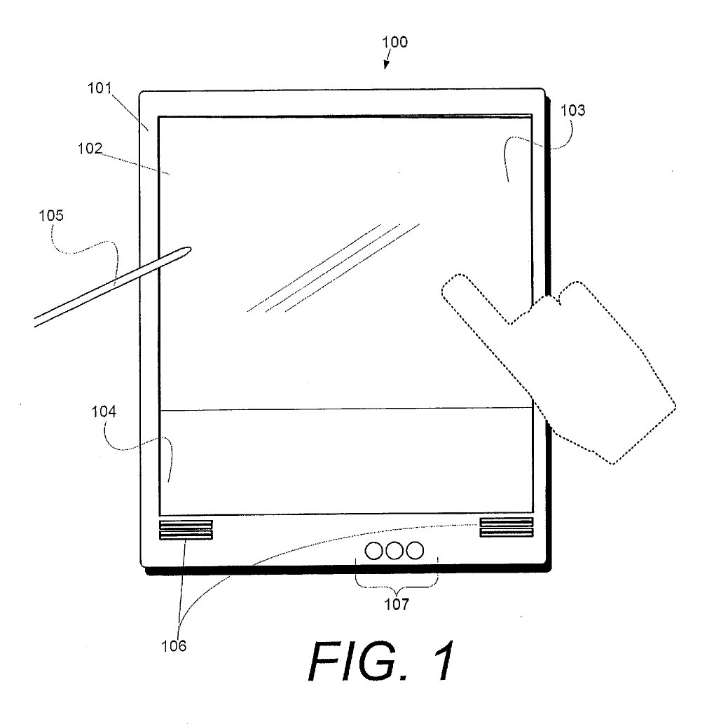

With reference to FIG. 1, a schematic diagram is shown corresponding to a portable electronic environment within which embodiments of the present invention may be implemented. The specific device exemplified in FIG. 1 is a tablet computer 100. Although the drawing is not intended to be precisely to scale, nor are the relative dimensions of devices used to implement the described principles intended to be limited to those shown, the device 100 may be approximately 8.5 inches wide and 11 inches in height. While the weight and thickness of the device 100 are typically minimized to the extent possible for user convenience, these parameters will be largely established by the weight and size of the components of the device.

Regarding externally visible features, the device 100 includes a case 101, containing a screen 102. The control of the display may be divided into a user-controlled portion 103 and an advertiser-controlled portion 104. These aspects will be described in greater detail later below. The device 100 as illustrated also includes one or more audio output devices 106 such as speakers, and one or more user-manipulable controls 107. For example, one such control 107 may be used to turn the device 100 on or off, and another may be usable to adjust the volume of audio projected by the audio output devices 106, while a third may be used to control screen brightness, etc.

The screen 102 of the device 100 may be touch-sensitive so that the user may perform manipulations and enter commands by touching, stroking, or otherwise interacting with the screen. Typically, the screen will be responsive to one or both of a stylus 105 and the user's hand or finger (shown in dotted outline). In an optional embodiment of the invention, the screen 102 is also responsive to the number of digits used to touch the screen 102.

It will be appreciated that the device 100 will generally include tangible non-transient computer-readable media (e.g., RAM, ROM, PROM, volatile, nonvolatile, or other electronic memory mechanism) for storing computer-executable instructions for executing the machine-implemented actions described herein as well as for data storage. The device 100 will typically also include one or more processors for executing those instructions. It will further be appreciated that this described environment is merely an example and does not imply any limitation regarding the use of other environments to practice the invention. For example, in an alternative embodiment of the invention, the environment is a desktop personal computer, and in another, the environment is a wireless communication device such as a cell phone.

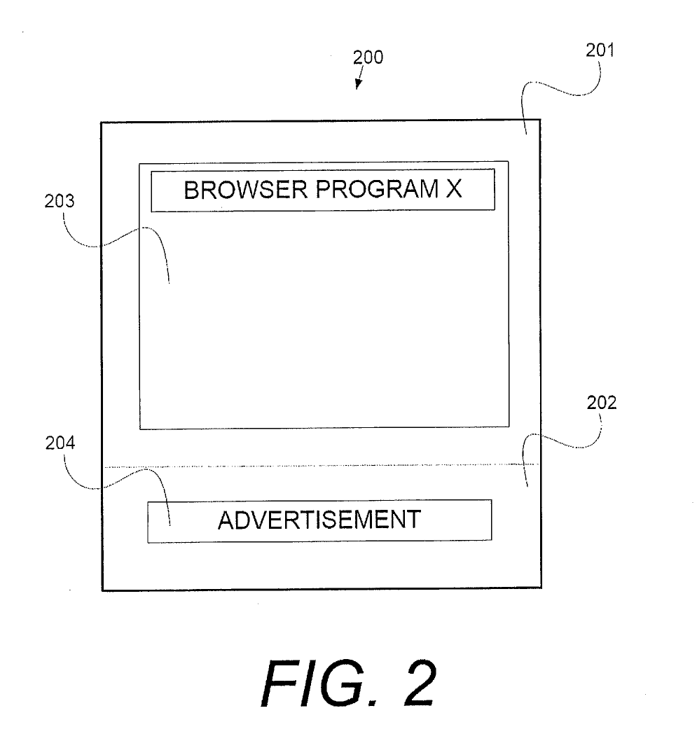

With continued reference back to the system of FIG. 1 for background knowledge, and turning now more specifically to FIG. 2, FIG. 2 is a schematic diagram of a portable electronic device screen 200 (102) having a user-controlled screen portion 201 (103) vertically set off from an advertiser-controlled screen portion 202 (104). The content 203 displayed in the user-controlled screen portion 201 (103) is generally selectable by the user. For example, the user may choose to display an email program, a web page, a text editor, etc.

In contrast, the content 204 displayed in the advertiser-controlled screen portion 202 (104) is not within the user's control, either is content, sequencing, sound, and so on. Thus, the advertiser may cause certain advertising material to appear in the advertiser-controlled screen portion 202 at the advertiser's discretion, and the user is not able to silence, cover, or remove the content 204.

In an embodiment of the invention, the device 200 (100) sense the presence or activity of the user, and displays advertising material only when the user is present and/or active. Thus, for example, within this optional embodiment of the invention, if the user sets the device down to attend to an errand or take a meal without shutting the device down, the device may sense the user's absence and cease displaying advertising materials until the user's return is detected.

In a further embodiment of the invention, the advertising material for display is stored locally on the device, i.e., in RAM, and is played during the user's presence. If the material becomes exhausted, the device may loop the previously played material again. In addition, if a source of additional material is present, e.g., a wireless connection to the internet, then the device may retrieve additional materials via that medium. This may be true regardless of the user's presence. For example, if the stored advertising material is 50% exhausted, the device may attempt to over write that portion with fresh material if a connection is available, even while the user is not present.

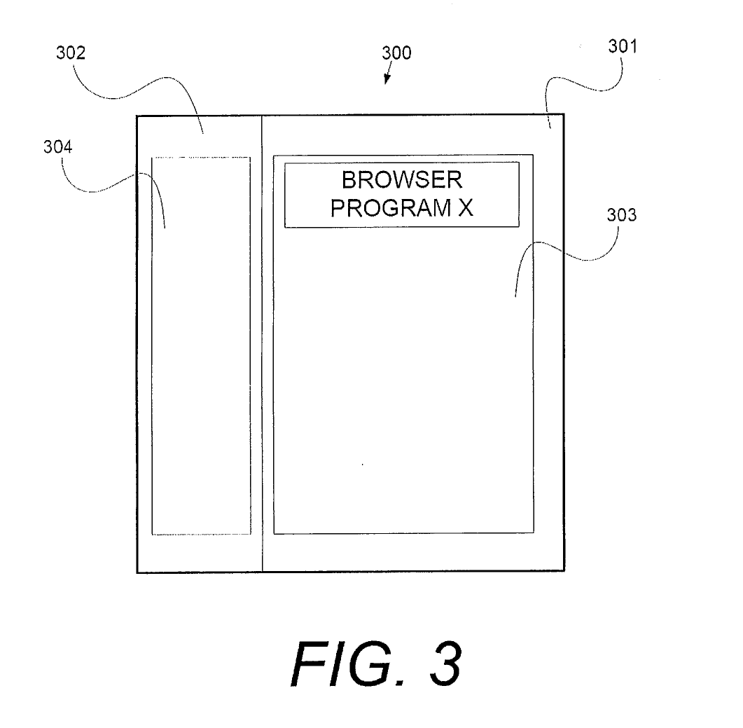

FIG. 3 is a schematic diagram of a portable electronic device screen having a user-controlled screen portion horizontally set off from an advertiser controlled screen portion. As with the embodiment of the invention illustrated in FIG. 2, the device of the embodiment of the invention shown in FIG. 3 includes a portable electronic device screen 300 (200) having a user-controlled screen portion 301 (201) and an advertiser-controlled screen portion 302 (202). In this case, however, the user-controlled screen portion 301 (201) is horizontally divided from the advertiser-controlled screen portion 302 (202). Similar to FIG. 2, however, only the content 303 (203) displayed in the user-controlled screen portion 301 (201) is manipulable by the user. For example, the user may choose to display and operate a program of their choosing in the user-controlled screen portion 301 (201), while this is not the case with the content 304 (204) shown in the advertiser-controlled screen portion 302 (202). Thus, as with screen 200, the advertiser may cause certain advertising material to appear in the advertiser-controlled screen portion 302 at the advertiser's discretion, and the user is not able to silence, cover, or remove the content 304.

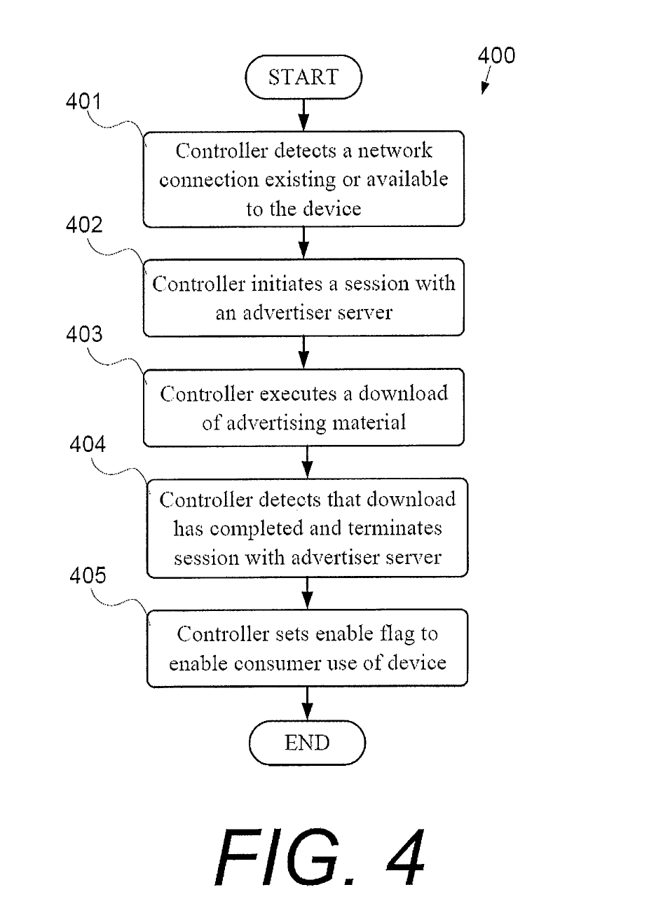

FIG. 4 is a flow chart showing a process for acquiring and refreshing advertising material in an embodiment of the invention. The described process flow assumes that the device may periodically encounter wireless connectivity to an information source such as the internet, but it will appreciated that in an environment where there is not connectivity after the initial download of material, then the steps regards refreshing of material may be omitted or may alternatively may be serviced via a flash drive, disc or other removable media. In this case, the device may be programmed to lock once the stored advertising material is exhausted, only to be unlocked by the transfer of additional specific materials from the removable media to the device. The operations regarding download and screen control at the device are executed by a resident controller, which may be a hardware or software controller (via the execution of computer-readable instructions from a CRM as discussed above).

At any rate, in the environment as assumed for the purposes of FIG. 4, the resident controller initially detects a network connection, e.g., a wireless connection, existing at the device, or available to the device, at stage 401. This may be a wireless connection via an access point or peer-to-peer network, or may represent the connection of a physical wired connection. Having detected the connection, the resident controller initiates a session with an advertiser server at stage 402, and executes a download of advertising material at stage 403. Subsequently at stage 404, the resident controller detects that the download has completed and terminates the session with the advertiser server. At stage 405, the resident controller sets an enable flag to enable consumer use of the device.

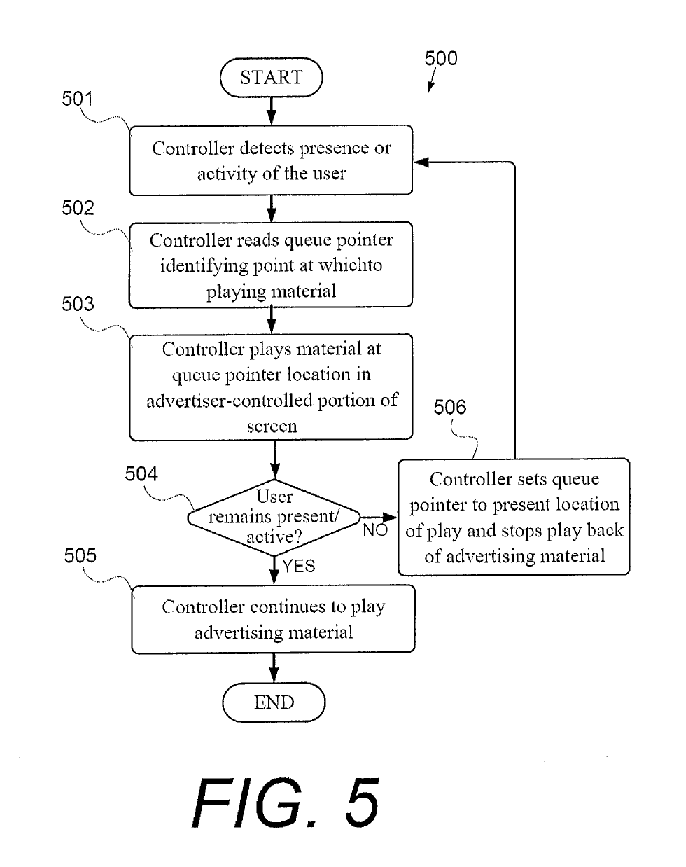

FIG. 5 is a flow chart showing a process for displaying advertising materials to a user of a portable device such as that shown in FIG. 1 within an embodiment of the invention. Although the advertising materials may have been obtained and stored in the manner shown in the process 400 of FIG. 4, any other suitable mechanism for obtaining and storing the materials may be employed.

At stage 501 of the process 500, the resident controller detects the presence or activity of the user. Having detected that the user is at least present, the resident controller reads a queue pointer at stage 502 that identifies a point in the advertising material at which to start playing the material. The pointer may identify a next file, a next point within a file, etc., based on the last material previously played. If the entire body of advertising material has been refreshed then the pointer may point to the start of the entire set of material.

At stage 503, the resident controller starts play of the advertising material starting at the queue pointer location in the advertiser-controlled portion of the screen. At stage 504, the resident controller determines whether the user remains present/active. If the user remains present or active, then the resident controller continues play of the advertising material at stage 505. If however, the resident controller determines that the user is no longer present/active, then the controller sets the queue pointer to the present location of play and stops the play back of advertising material at stage 506. After setting the queue pointer the process 500 returns to stage 501 to await an indication that the user is once again present/active.

In an embodiment of the invention, the resident controller periodically presents a challenge to the user to ensure that the user has observed the advertiser-controlled portion of the screen. For example, the user may be asked to input a series of digits or numbers, or to click or select a certain area or object on either portion of the screen. If the user successfully completes the challenge, then the resident controller allows the user to continue to use the device including the user-controlled portion of the screen. Otherwise, the resident controller may lock the user out of the device, or blank the user-controlled portion of the screen, until the user successfully completes a challenge.

However, the invention is not limited to devices in which the advertising window cannot be covered up or ignored. Thus, while in some embodiments of the invention the user is discouraged from covering the window, in a further embodiment of the invention, the user is able to pay to have the advertising turned off via a wireless link to give the user full use of the tablet. In further embodiments of the invention, additional upgrades include turning on hidden features such as 3G service, GPS, access to additional memory, ability to download external apps, etc.

As noted above, the described scheme is beneficial to the advertiser in that they are able to ensure an audience for their advertising materials. Similarly, the devices are distributed in a manner that also benefits users. In particular, one method of supplying the devices is for an advertiser or their agent to provide the devices free of charge to target consumers. In exchange for the free electronic device, the user agrees to accept the advertising placement on the machine. With or without the user's express acceptance of that term however, the device is provided with a resident controller, not overridable by the user, which splits the screen into user-controlled and advertiser-controlled portions as discussed above.

The agent supplying the device to the user may contract with several different advertisers, and the advertising material loaded (and refreshed) on the device may advertise each contracted advertiser's product in turn. The identity of the advertisers may change, and the content may be updated accordingly. For example, the agent may contract with each advertiser on a subscription basis for a monthly or other periodic fee. Thus, because the content on the device may be updated, the device can continue to generate advertising revenue for the agent by contracting with a series of advertisers or groups thereof. This advertising revenue may offset the initial cost of each device to the agent in addition to providing an income stream. However, it will be appreciated that advertising may only partially offset costs, or indeed where the advertising is not used to offset these costs at all.

Although the described embodiments have been discussed by reference to a personal tablet having a portion used for advertising, it will be appreciated that the split screen control described could be used in other ways as well. For example, it is also possible to implement the invention in any tablet or mobile device application in which there is a user portion of the screen and a controlled part of the screen. Such other embodiments of the invention need not involve advertising.

For example, one implementation intended for military use involves a tablet wherein one portion is used by the end user and the other is used by command and control for conveying important information to the soldier or user. Other uses would include industrial implementations wherein the controlled portion of the screen is used by management to convey company-wide information. Moreover, although the invention has been described in the context of a split screen, it will be appreciated that embodiments of the invention may use two separate screens rather than a single split screen.

While the foregoing discussion gives examples illustrating a horizontal or vertical portion of the window being used for advertising, it will be appreciated that these examples are illustrative only. Indeed, within the invention, any portion of the window that is always non-user controlled may be used, regardless of size, shape or location. The primary point in any such embodiments of the invention is that the user cannot remove this portion of the display.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A computerized device for viewing and by a user, the device comprising:
a display screen having a display area;
a controller for displaying visual material in the display area, wherein the controller is adapted to provide a user-controlled portion of the display area and a user-independent portion of the display area, and wherein the user is able to manipulate the visual material and operations occurring with respect to the user-controlled portion of the display area but not with respect to the user-independent portion of the display area.

2. The computerized device according to claim 1, wherein the controller is adapted to display advertising material in the user-independent portion of the display area.

3. The computerized device according to claim 1, wherein the controller is adapted to display emergency notification material in the user-independent portion of the display area.

4. The computerized device according to claim 1, wherein the controller is adapted to obtain the advertising material from a memory on the device.

5. The computerized device according to claim 1, wherein the controller is adapted to manage the advertising material displayed in the user-independent portion of the display area by periodically obtaining new advertising materials from a source external to the device.

6. The computerized device according to claim 5, wherein the controller is adapted to periodically obtain the new advertising materials via a wireless connection to the source external to the device.
